(19) United States
(12) Patent Application Publication
(10) Pub. No.: US 2025/0164272 A1
(43) Pub. Date: May 22, 2025

(54) SEARCH CATEGORY VARYING METHOD BASED ON PASSENGER CONTEXT AND NAVIGATION SYSTEM FOR PERFORMING THE SAME

(71) Applicant: HYUNDAI AUTOEVER CORP., Seoul (KR)

(72) Inventors: Won Mi AHN, Seoul (KR); Moon Jeong KIM, Seoul (KR); So Jung KIM, Seoul (KR); Suk Ho LEE, Seoul (KR); Yeon Su KIM, Seoul (KR); Hwa Hyeon HONG, Seoul (KR)

(21) Appl. No.: 18/951,821

(22) Filed: Nov. 19, 2024

(30) Foreign Application Priority Data
Nov. 20, 2023 (KR) 10-2023-0161426

(51) Int. Cl. G01C 21/36; G06F 16/28; G07C 5/00; G07C 5/08

(52) U.S. Cl. CPC G01C 21/3679; G01C 21/3691; G01C 21/3697; G06F 16/287; G07C 5/004; G07C 5/006; G07C 5/0808

(57) ABSTRACT

Search category varying methods and devices are described. According to an embodiment, a method comprises obtaining from a vehicle a vehicle information indicating a state of the vehicle, obtaining a context information indicating a situation of a passenger using the vehicle information; determining respective priorities of a plurality of surrounding search categories based on the context information, and displaying the plurality of surrounding search categories under the respective priorities.

### CROSS-REFERENCE TO RELATED APPLICATION

This application claims priority from Korean Patent Application No. 10-2023-0161426 filed on Nov. 20, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a search category varying method based on passenger context and a navigation system for performing the same. More specifically, the present disclosure relates to a method for variably providing search categories based on passenger context and situation identified by utilizing information obtainable from an inside of a vehicle, and a navigation system for performing the same.

### Description of Related Art

Generally, each of various mobility apparatuses employs a navigation system equipped with a GPS (Global Positioning System) to identify a current location and a current moving speed thereof or to determine a moving speed thereof. The navigation system receives a radio wave indicating a latitude, a longitude, an altitude, etc. from a plurality of artificial satellites, calculates a current location of a moving object to identify the current location of the moving object, and identifies a destination input by a user, and determines a moving route starting from the current location and arriving at the destination.

The navigation system determines the route based on various information related to driving, such as to a distance the destination, an arrival time, a cost such as an optimal distance to the destination, the shortest distance, a traffic condition, use of free or toll road, etc. The navigation system includes not only a component for receiving the destination directly from the user, but also a component that searches for the current location or the surroundings around the destination.

For example, when a user wants to find a restaurant or parking lot around a destination, the navigation system may display restaurants or parking lots as a search category around the destination to display a list of restaurants or parking lots around the destination. In this regard, depending on an order in which the search categories around the destination are displayed, the user may easily find the desired category or not. In other words, a configuration of the navigation system needs to be individualized under the user's situation and the vehicle's status. Therefore, research is needed to vary the order in which the search categories around the destination are displayed depending on the user's situation.

### SUMMARY

A technical purpose to be achieved using embodiments of the present disclosure is to provide a method in which the navigation system identifies the situation of the passenger based on information on the vehicle status that may be obtained from the inside of the vehicle, and varies a search category for surroundings, based on the identified passenger's situation.

The technical purposes of the present disclosure are not limited to the technical purposes mentioned above, and other technical purposes not mentioned may be clearly understood by those skilled in the art from descriptions as set forth below.

According to an aspect of the present disclosure, a computing device may comprise: a processor; and a memory connected to the process and configured to store therein instructions, wherein when the instructions are executed by the processor, the instructions cause the processor to perform: obtaining vehicle information indicating a state of a vehicle from the vehicle; obtaining context information indicating a situation of a passenger using the acquired vehicle information; determining respective priorities of a plurality of surrounding search categories, based on the acquired context information; and displaying the plurality of surrounding search categories under the determined priorities.

In an embodiment, wherein the vehicle information may include at least one of vehicle location information, whether a child lock is activated, DTE (distance to empty) information indicating a fuel level, whether a warning signal is received from the vehicle, whether a wiper is in operation, whether a sunroof is open or closed, or a weight of a loaded cargo.

In an embodiment, wherein the determining the respective priorities of the plurality of surrounding search categories may include setting a priority of a first surrounding search category related to the acquired context information among the plurality of surrounding search categories to a highest or lowest level.

In an embodiment, wherein the determining the respective priorities of the plurality of surrounding search categories may include determining a priority related to each of items of the first surrounding search category.

In an embodiment, wherein the obtaining the context information indicating the situation of the passenger includes obtaining the context information using information about a current time, real-time traffic situation, and a specific location.

In an embodiment, wherein the obtaining the context information indicating the situation of the passenger may include: comparing obtained current location information with reference location information; determining whether a distance between the current location and the reference location is greater than or equal to a first threshold value; and obtaining context information indicating that the passenger is traveling when the distance between the current location and the reference location is greater than or equal to the first threshold value.

In an embodiment, wherein the obtaining the context information may indicating that the passenger is traveling may include: determining whether a distance between a destination and a first location is smaller than a second threshold value; and obtaining context information indicating that the passenger is traveling to the first location when the distance between the destination and the first location is smaller than the second threshold value.

In an embodiment, wherein the obtaining the context information indicating the situation of the passenger may include: determining whether a child lock is turned on; and obtaining context information indicating that a child is seated in the vehicle when the child lock is turned on.

In an embodiment, wherein the determining the respective priorities of the plurality of surrounding search categories may include: determining whether children are allowed to enter each of items of each of the plurality of surrounding search categories; and determining a priority of each of the items based on a result of the determination of whether children are allowed to enter each item.

In an embodiment, wherein the obtaining the context information indicating the situation of the passenger may include: determining whether a current time is included in a preset meal time; and obtaining context information indicating that the current time is a meal time when the current time is included in the preset meal time.

In an embodiment, wherein the obtaining the context information indicating the situation of the passenger may further include: determining whether a departure point is a meal place; and obtaining context information indicating that the current time is a dessert time when the departure point is the meal place.

In an embodiment, wherein the obtaining the context information indicating the situation of the passenger may further include: determining whether a destination is a downtown area; obtaining population density information of the destination based on obtained location information, when the destination is the downtown area; determining whether the population density of the destination is greater than or equal to a first threshold value; and obtaining context information indicating that a parking space is required when the population density of the destination is greater than or equal to the first threshold value.

In an embodiment, wherein the obtaining the context information indicating the situation of the passenger may include: determining whether DTE (distance to empty) is smaller than a first threshold value; and obtaining context information indicating that refueling or charging is required when the DTE is smaller than the first threshold value.

In an embodiment, wherein the obtaining the context information indicating the situation of the passenger may include: determining whether a warning signal has been received from the vehicle; and obtaining context information indicating that maintenance of the vehicle is required when the warning signal has been received therefrom.

In an embodiment, wherein the obtaining the context information indicating the situation of the passenger may include: determining whether a wiper of the vehicle has been operating for a first threshold time or larger; and obtaining context information indicating that it is raining when the wiper of the vehicle has been operating for the first threshold value or larger.

In an embodiment, wherein the obtaining the context information indicating the situation of the passenger may include: determining whether a sunroof of the vehicle has been open for a first threshold time or larger; and obtaining context information indicating that the passenger is driving in non-rainy weather when the sunroof of the vehicle has been open for the first threshold time or larger.

In an embodiment, wherein the obtaining the context information indicating the situation of the passenger may include: determining whether there is a camping site among destinations set by the passenger; determining whether a weight of a cargo loaded on the vehicle is greater than or equal to a first threshold value when there is the camping site among the set destinations; and obtaining context information indicating that the passenger is moving to the camping site when the weight of the cargo loaded on the vehicle is greater than or equal to the first threshold value.

According to another aspect of the present disclosure, a search category varying method may be performed by a computing device, and the method may comprise: obtaining vehicle information indicating a state of a vehicle from the vehicle; obtaining context information indicating a situation of a passenger using the acquired vehicle information; determining respective priorities of a plurality of surrounding search categories, based on the acquired context information; and displaying the plurality of surrounding search categories under the determined priorities.

In an embodiment, wherein the vehicle information may include at least one of vehicle location information, whether a child lock is activated, DTE (distance to empty) information indicating a fuel level, whether a warning signal is received from the vehicle, whether a wiper is in operation, whether a sunroof is open or closed, or a weight of a loaded cargo.

In an embodiment, wherein the determining of the respective priorities of the plurality of surrounding search categories may include setting a priority of a first surrounding search category related to the acquired context information among the plurality of surrounding search categories to a highest or lowest level.

### BRIEF DESCRIPTION OF DRAWINGS

The above and other aspects and features of the present disclosure will become more apparent by describing in detail illustrative embodiments thereof with reference to the attached drawings, in which:

FIG. 1 shows an example of an environment to which a navigation system performing a search category varying method according to some embodiments of the present disclosure may be applied;

FIG. 2 shows an example of an initial screen of the navigation system of FIG. 1;

FIG. 3 shows an example of a surrounding search screen of the navigation system of FIG. 1;

FIG. 4 shows an example of a category-related list screen displayed when each category is selected on the surrounding search screen of FIG. 3;

FIG. 5 is a flowchart for illustrating a method for varying a surrounding search category according to an embodiment of the present disclosure;

FIG. 6 is a flowchart for illustrating an embodiment of a step of obtaining context information of FIG. 2;

FIG. 7 is a flowchart for illustrating an embodiment of each of a step of obtaining context information of FIG. 2 and a step of determining priority of each of a plurality of surrounding search categories;

FIG. 8 is a flowchart for illustrating an embodiment of a step of obtaining context information of FIG. 2;

FIGS. 9 to 10 illustrate a surrounding search screen that varies according to an embodiment of FIG. 8;

FIG. 11 illustrates a category-related list screen that varies according to an embodiment of FIG. 7;

FIGS. 12 to 17 are flowcharts for illustrating an embodiment of a step of obtaining context information of FIG. 2; and

FIG. 18 is a block diagram illustrating a hardware configuration of a computing device for performing a search category varying method according to an embodiment of the present disclosure.

### DETAILED DESCRIPTIONS

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

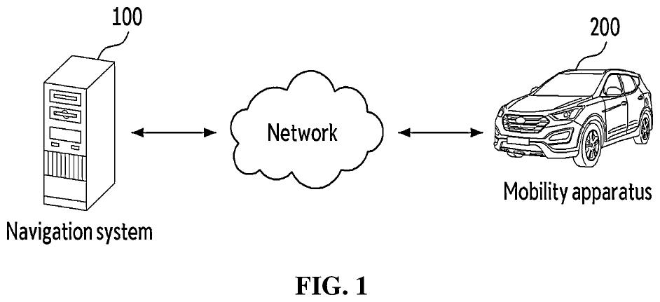

FIG. 1 shows an example of an environment to which a navigation system 100 for performing a search category varying method according to an embodiment of the present disclosure may be applied. The navigation system 100 may provide a surrounding search category varying function via communication with a mobility apparatus 200. Specifically, the navigation system 100 according to an embodiment of the present disclosure may obtain information indicating the status of the mobility apparatus 200 from the mobility apparatus 200, identify a passenger situation of the mobility apparatus 200 based on the obtained information, and vary the surrounding search category based on the identified passenger situation. For example, the varying of the surrounding search category may include adjusting an order in which the surrounding search categories are displayed. Hereinafter, for the convenience of the description, the mobility apparatus 200 is assumed to be a vehicle. However, the present disclosure is not limited thereto.

For example, information indicating the status of the vehicle 200 may include information on the vehicle's location (GPS), whether a child lock is activated, DTE (distance to empty) information indicating a fuel level, whether a warning signal is received, whether the wipers are operating, whether the sunroof is open or closed, and a weight of a loaded cargo. The navigation system 100 may identify whether the passenger is currently located within a predefined range around the main activity place such as home or workplace, or not based on the vehicle's location information. Furthermore, whether a child is getting into the vehicle may be identified based on whether the child lock is activated. Whether refueling or charging is required may be identified based on the DTE information. The weather state may be identified based on whether the wipers are operating.

For example, when the passenger is determined to be away from the predefined range around the main activity place, it may be determined that the passenger is traveling. Thus, the navigation system 100 may preferentially display categories related to traveling (tourist attractions, restaurants, scenic roads, etc.). When it is determined that a child is present in the vehicle, the navigation system 100 may not display a place into which the children are not allowed to enter (so-called no-kids zone) in the category-related list. When it is determined based on the DTE information that refueling or charging is necessary, the navigation system 100 may preferentially display the gas station/charging station category. When the wipers are continuously operating, it may be determined that it is rainy. In this case, the navigation system 100 may set the car wash category to have a lower priority. The navigation system 100 may vary the surrounding search category based on the above-identified situation. Furthermore, the navigation system 100 according to an embodiment of the present disclosure may vary the surrounding search category additionally using a current time, real-time traffic situation, information on a specific place (for example, population density information of a currently located city or destination) in addition to the information indicating the status of the vehicle 200 as described above.

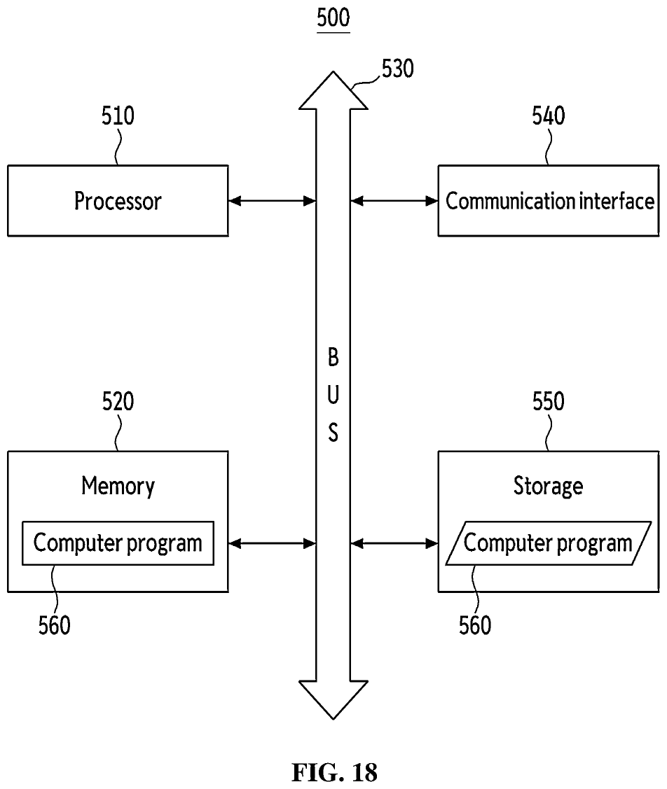

The navigation system 100 according to an embodiment of the present disclosure may be implemented on at least one computing device. For example, all functions of the navigation system 100 may be implemented on one computing device. Alternatively, some functions of the navigation system 100 may be implemented on a first computing device, and the remaining functions thereof may be implemented on a second computing device. Alternatively, a specific function of the navigation system 100 may be implemented on a plurality of computing devices. For example, the surrounding search category varying function and the function of displaying information about the destination of the navigation system 100 may be implemented separately on different computing devices. The computing device may include any device equipped with a computing means and a communication means. An embodiment in which the navigation system 100 is embodied as the computing device is described in more detail with reference to FIG. 18.

Furthermore, the components illustrated in FIG. 1 may communicate with each other through a network. For example, the network may be embodied as any type of wired/wireless network such as a Local Area Network (LAN), a Wide Area Network (WAN), a mobile radio communication network, and Wibro (Wireless Broadband Internet).

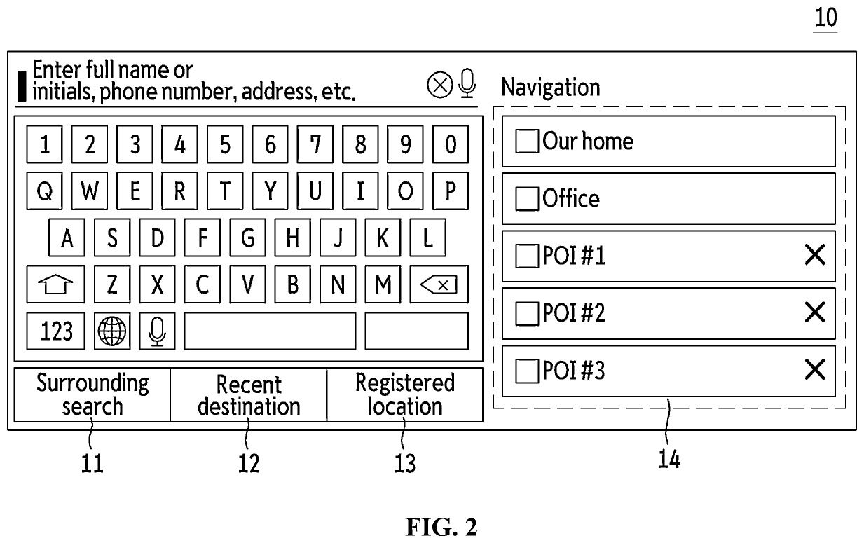

Hereinafter, with reference to FIGS. 2 to 4, a user interface of the navigation system 100 will be described.

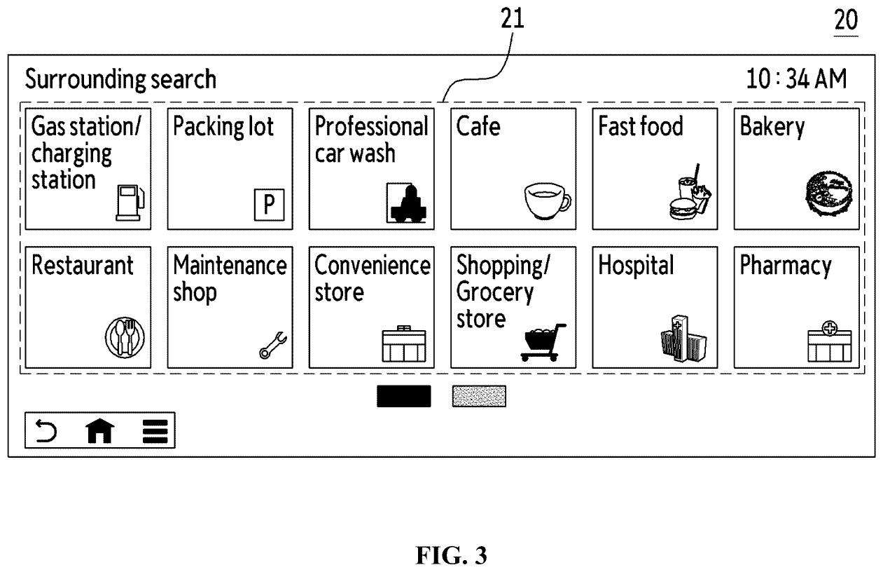

FIG. 2 illustrates an example of an initial screen 10 of the navigation system 100 of FIG. 1. Referring to FIG. 2, the navigation system 100 may receive a search word from a passenger of the vehicle 200 and display information related to one or more destinations corresponding to the input search word on the screen. Referring to FIG. 2, the initial screen 10 may display a surrounding search button 11, a recent destination button 12, and a registered location button 13. When the surrounding search button 11 is pressed, search categories of current location surrounding, destination surrounding, route surrounding, or specific area surrounding may be displayed. When the recent destination button 12 is pressed, destinations corresponding to a recently entered search word may be displayed. When the registered location button 13 is pressed, destinations with high search frequency (e.g., home, office, etc.) may be displayed. For example, locations 14 displayed at the right side of the initial screen 10 as shown in FIG. 2 may be a list of registered destinations. The screen displayed when the surrounding search button 11 is pressed will be described above with reference to FIG. 3.

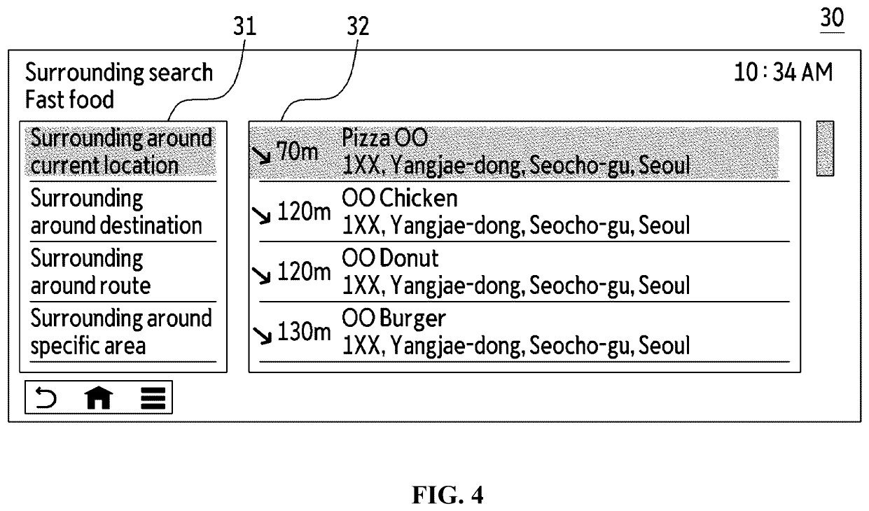

FIG. 3 shows an example of a surrounding search screen 20 of the navigation system 100 of FIG. 1. Referring to FIG. 3, a plurality of surrounding search categories 21 are displayed on the surrounding search screen 20. When the passenger selects each of the categories, destinations corresponding to the selected category may be displayed. The surrounding search may be used when a destination is not set and the user wants to search for places existing in surroundings of the current location, the destination, the route, or the specific area. For example, when the user wants to search for restaurants in the surrounding or parking lots in the surrounding while the destination is not set, the surrounding search may be used. According to the present disclosure, a priority of each of the plurality of surrounding search categories 21 may be determined based on the situation of the passenger identified based on information indicating the status of the vehicle, and the plurality of surrounding search categories 21 may be displayed based on the determined priorities. The screen displayed when each category is selected is described above with reference to FIG. 4.

FIG. 4 shows an example of a category-related list screen 30 displayed when each category is selected in the surrounding search screen 20 of FIG. 3. Referring to FIG. 4, at the left side of the category-related list screen 30, an interface 31 for selecting a reference location (current location, destination, route, or specific area) for the surrounding search, while at the right side thereof, a list 32 including the names of, detailed addresses of, and distances to places belonging to the selected search category may be displayed. When one of the places in the list 32 is selected, information related to the selected place may be displayed on the navigation system 100.

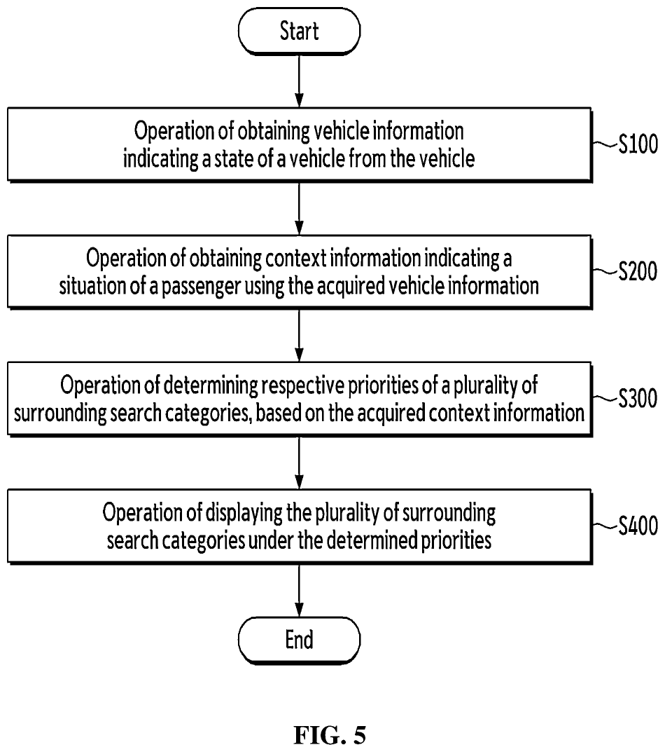

FIG. 5 is a flowchart for illustrating a surrounding search category varying method according to an embodiment of the present disclosure. For reference, FIG. 5 shows steps/operations performed in the navigation system 100 of FIG. 1. Therefore, it may be understood that, in following descriptions, when a subject of a specific step/operation is omitted, the step/operation is performed in the navigation system 100 of FIG. 1. Furthermore, as described above with reference to FIG. 1, the mobility system 200 of FIG. 1 is assumed to be a vehicle. However, the present disclosure is not limited thereto, and embodiments as described below may be applied to all mobility apparatuses 200 other than the vehicle. Hereinafter, the method of FIG. 5 will be described above with reference to FIGS. 1 to 4.

In operation S100, vehicle information indicating the state of the vehicle may be acquired from the vehicle. For example, as described above with reference to FIG. 1, the information indicating the status of the vehicle 200 may include information on the vehicle's location (GPS), whether a child lock is activated, DTE (distance to empty) information indicating a fuel level, whether a warning signal is received, whether the wipers are operating, whether the sunroof is open or closed, and a weight of a loaded cargo. The vehicle information is characterized by not being information that may be obtained from an outside out of the vehicle or through other devices but being information about the vehicle's status that may be obtained from the inside of the vehicle.

In operation S200, context information indicating the situation of the passenger may be obtained using the acquired vehicle information. For example, as described above with reference to FIG. 1, the context information may include information about whether the passenger is traveling, information about whether a child is seated, information about whether a parking place is needed, information about whether refueling or charging is needed, and information about whether the vehicle needs maintenance. Furthermore, information such as whether the current time is a meal time, whether the current time is dessert time after a meal, and whether it is raining may also be included in the context information. In addition, in operation S200, in addition to the vehicle information as described above, information about the current time, real-time traffic situation, and specific location (e.g., population density information of the currently located city or destination) may be additionally used to obtain the context information.

In operation S300, respective priorities of the plurality of surrounding search categories may be determined based on the obtained context information. For example, as described above with reference to FIG. 1, when a passenger is traveling, a priority of tourist attractions, restaurants, or scenic roads may be set to be high. When a child is present in the vehicle, the navigation system 100 may be configured not to display a place into which the children are not allowed to enter (so-called no-kids zone) in the category-related list. Furthermore, when a parking space is required, a priority of the parking lot may be set to be high. When refueling or charging is required, the priority of the gas station or charging station may be set to be high. When vehicle maintenance is required, the priority of the maintenance shop may be set to be high. In addition, when the current time is a meal time or dessert time, the priority of restaurants, fast food, cafes, bakeries, etc. may be set to be high. When it is raining, the priority of a professional car wash may be set to be low. In operation S400, the plurality of surrounding search categories may be displayed under the determined priorities.

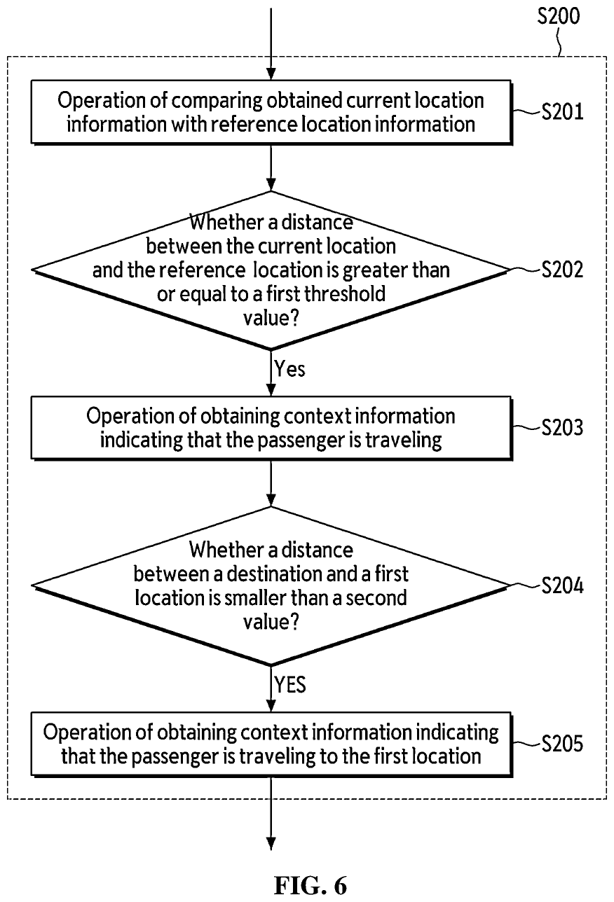

Hereinafter, with reference to FIGS. 6 to 17, various embodiments related to operation S200 will be reviewed. The embodiments as shown in FIGS. 6 to 17 are merely examples. According to some embodiments of the present disclosure, in addition to the information as described above with reference to FIGS. 6 to 17, more various context information may be obtained based on more various vehicle information.

FIG. 6 is a flowchart for illustrating an embodiment of operation S200 of obtaining context information of FIG. 2. Referring to FIG. 6, in operation S201, the vehicle's location (GPS) information and reference location information may be compared with each other. For example, the reference location information may be location information of a main activity place, such as a home or a workplace. In operation S202, it may be determined whether a distance between the current location and the reference location is greater than or equal to a first threshold value. When the distance between the current location and the reference location is determined to be greater than or equal to the first threshold value (YES), it may be determined that the current location is far away from a predefined range around the main activity place. Thus, in operation S203, the context information indicating that the passenger is traveling may be obtained. In this case, in operation S300, the priority of the surrounding search category (tourist attraction, restaurant, cafe, scenic road, etc.) related to the traveling may be set to be high.

Furthermore, in operation S204, it may be determined whether a distance between the destination input from the passenger and a first location is smaller than a second threshold value. When the distance between the destination and the first location is determined to be smaller than the second threshold value (YES), in operation S205, context information indicating that the passenger is traveling to the first location may be additionally obtained. For example, when the first location is a coast, the priority of the scenic road or beach among the surrounding search categories may be set to be high. Furthermore, in the scenic road category, a coastal road may be preferentially displayed. In the restaurant or cafe category, a restaurant or cafe adjacent to the sea may be preferentially displayed. Although an example in which the first location in operations S204 to S205 is the coast is described above, the present disclosure is not limited thereto. Operations similar to operations S204 to S205 may be performed in relation to other terrains or locations other than the coast.

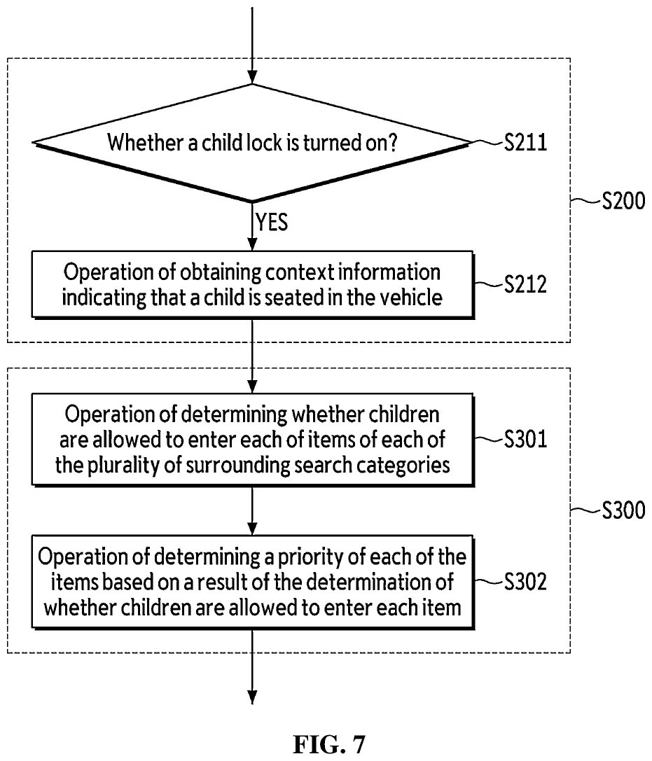

FIG. 7 is a flowchart for illustrating an example of operation S200 of obtaining context information in FIG. 2 and operation S300 of determining the priority of each of the plurality of surrounding search categories. Referring to FIG. 7, in operation S211, it may be determined whether a child lock is turned on. When it is determined that the child lock is turned on (YES), in operation S212, context information indicating that the child is present in the vehicle may be acquired. For example, when a child is present in the vehicle, a priority of a category related to children, such as an amusement park, may be set to be high.

In addition, operation S300 of determining the priority of each of the plurality of surrounding search categories according to an embodiment may include determining the priority of each of items of each category. When context information indicating that a child is seated in the vehicle is obtained through operations S211 to S212, in operation S301, whether children is allowed to enter each of the items of each of the plurality of surrounding search categories may be determined, and in operation S302, the priority of each of the items may be determined based on the determination result of operation S301. For example, the priority of a place which the children are not allowed to enter may be determined to be the lowest, and thus, the place which the children are not allowed to enter may not be displayed in the category-related list.

Although the case where the priorities of the items of the category are set to be different from each other, based on whether children are allowed to enter has been described, the present disclosure is not limited thereto. The priorities of the items of the category may be set to be different from each other in various ways based on the acquired context information.

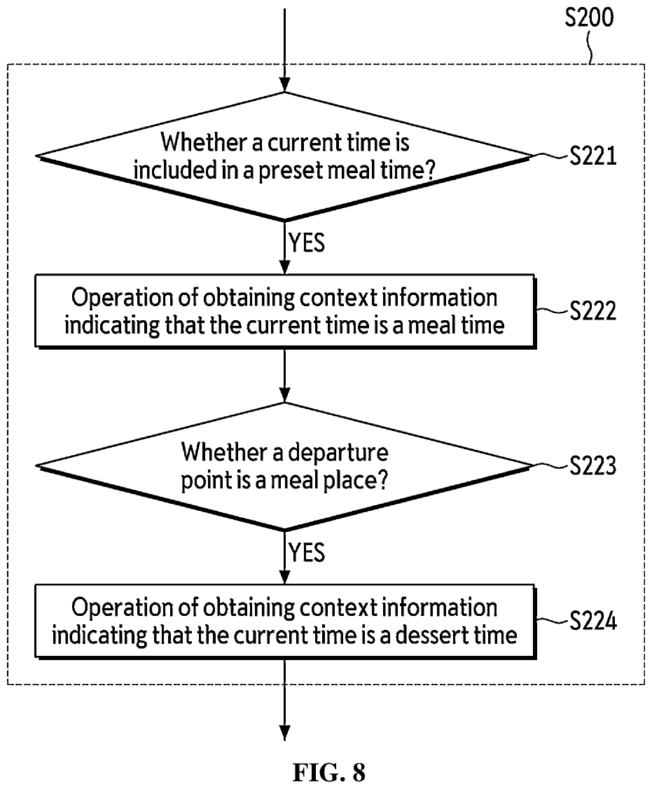

FIG. 8 is a flowchart for illustrating an embodiment of operation S200 of obtaining context information of FIG. 2. Referring to FIG. 8, in operation S221, it may be determined whether the current time is included in a preset meal time. For example, the lunch time may be set to a range from 11:30 AM to 1:30 PM, and the dinner time may be set to a range from 5:30 PM to 7:30 PM. When the current time is included in the preset meal time (YES), context information indicating that the current time is the meal time may be acquired in operation S222. In this case, in operation S300, the priority of restaurants, fast food, cafes, bakeries, etc. may be set to be high.

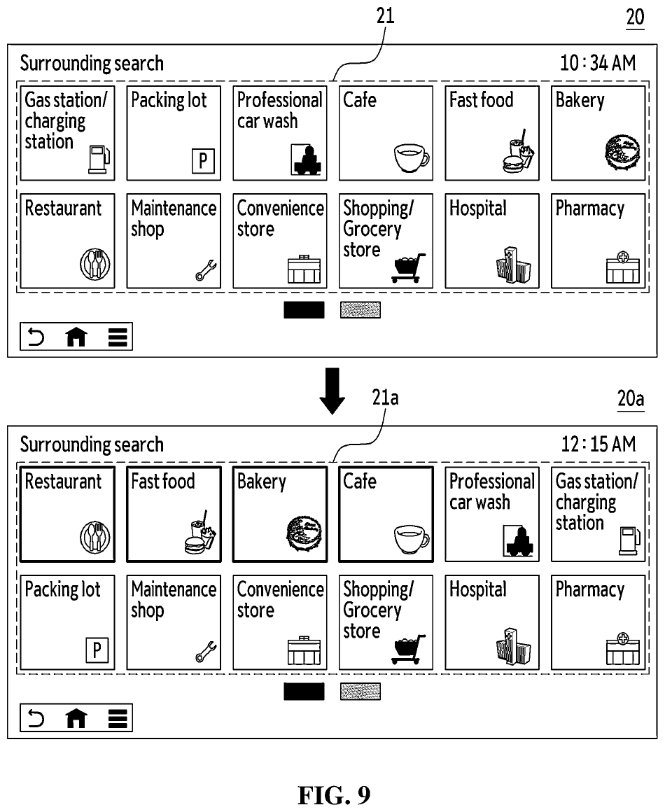

In one example, in operation S223, it may be determined whether a starting point on the navigation system is a meal place. When the starting point is the meal place at the meal time (YES), it may be determined that the meal has already been finished, and in operation S224, context information indicating that the current time is dessert time may be acquired. In this case, in operation S300, the priority of a cafe, bakery, etc. may be set to be high. Hereinafter, with reference to FIGS. 9 to 11, the interface of the navigation system 100 that changes according to the above-described embodiments will be reviewed.

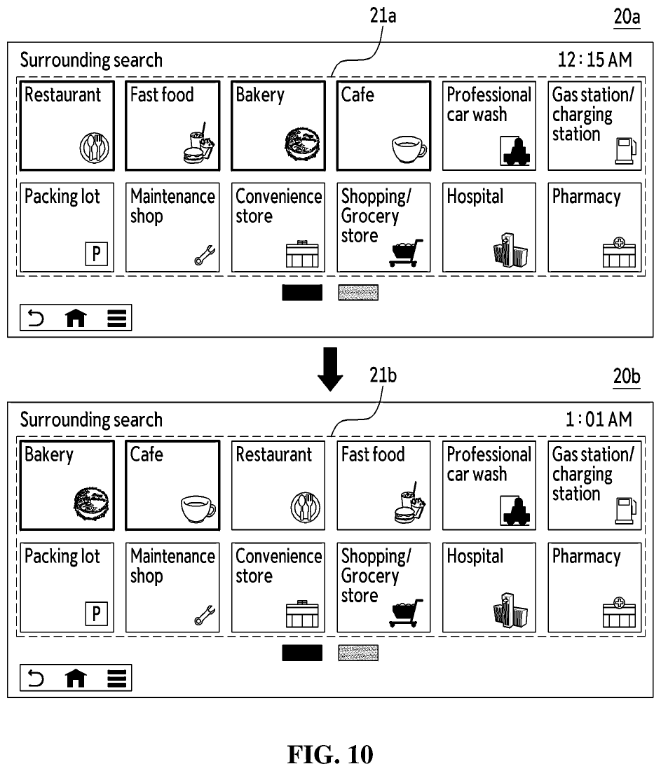

FIGS. 9 to 10 show examples of surrounding search screens 20, 20a, and 20b that change according to an embodiment of FIG. 8. For example, FIG. 9 may show a surrounding search screen 20 to which the context information has not yet applied, and a surrounding search screen 20a to which the context information indicating that the current time is the lunch time has been applied. Referring to FIG. 9, it may be identified that the priorities of restaurants, fast food, bakeries, and cafes among the plurality of surrounding search categories 21a are set to be higher during the lunch time (e.g., 12:15 p.m.), compared to non-lunch time (e.g., 10:34 a.m.), and the restaurants, fast food, bakeries, and cafes are displayed in front of other categories.

Furthermore, FIG. 10 may show the surrounding search screen 20a to which the context information indicating that the current time is the lunch time has been applied, and the surrounding search screen 20b to which the context information indicating that the current time is the dessert time has been applied. For example, the surrounding search screen 20b may be a screen displayed when the starting point has been a place to eat (e.g., a place included in the restaurant category or the fast food category) during the lunch time. Referring to FIG. 10, it may be identified that the priorities of bakeries and cafes among the plurality of surrounding search categories 21b are set to be higher during the dessert time compared to the lunch time, and the bakeries and cafes are displayed in front of other categories.

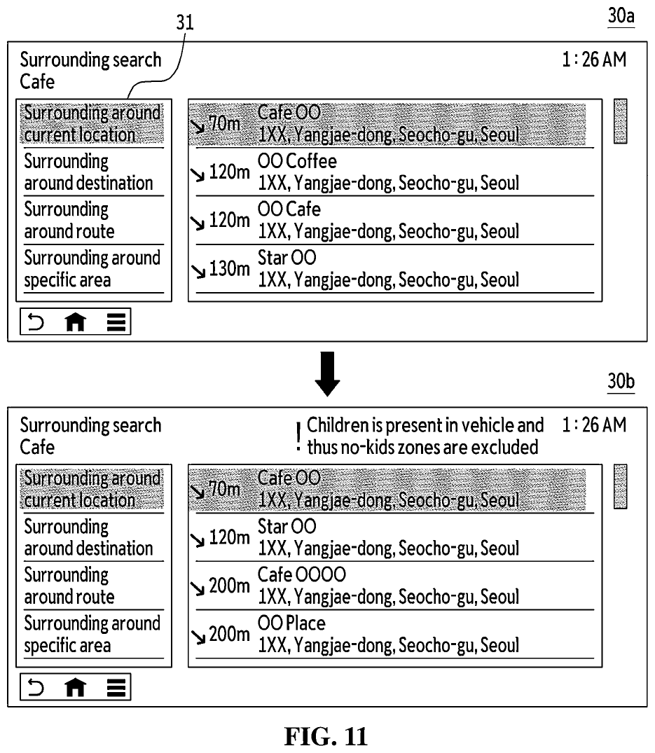

FIG. 11 shows an example of a category-related list screen 30a and 30b that changes according to an embodiment of FIG. 7. According to an embodiment of FIG. 7, when the child lock is turned on and thus, the context information indicating that a child is seated in the vehicle is obtained, whether or not the child is allowed to enter each category-related item may be determined. The place which a child is not allowed to enter may be set to have a low priority and may be not displayed in the list. For example, the screen 30a shows a case where context information indicating that the child is seated in the vehicle is not obtained. The screen 30b shows a case where context information indicating that a child is seated in the vehicle is obtained. For example, when it is assumed that OO Coffee and OOO Cafe 31 belonging to the cafe category of the screen 30a are places which the children are not allowed to enter, the places OO Coffee and OOO Cafe may not be displayed in the list of the screen 30b.

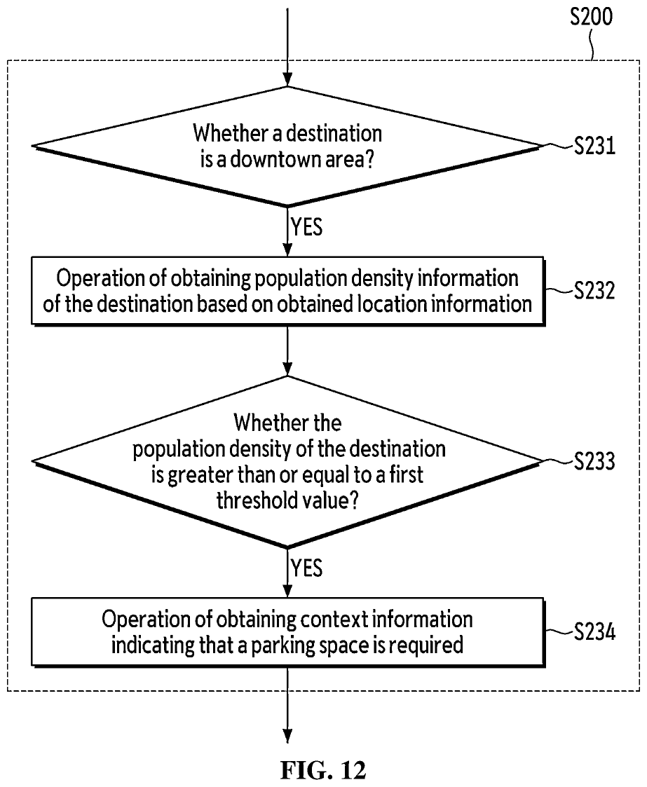

FIG. 12 to FIG. 17 are flowcharts for illustrating an embodiment of operation S200 of obtaining context information of FIG. 2.

Referring to FIG. 12, in operation S231, it may be determined whether the destination set by the passenger is a downtown area. When the destination is the downtown area (YES), in operation S232, population density information of the destination may be additionally obtained based on the acquired location information. For example, the population density information of the destination may be stored in any server connected to the navigation system 100 via a network. In operation S233, it may be determined whether the population density information is greater than or equal to a first threshold value. When it is determined that the population density information is greater than or equal to the first threshold value (YES), the destination is determined to be the crowded downtown area of a metropolis, and thus, in operation S234, context information indicating that a parking space is required may be obtained. In this case, in operation S300, the priority of the parking lot category may be set to be high.

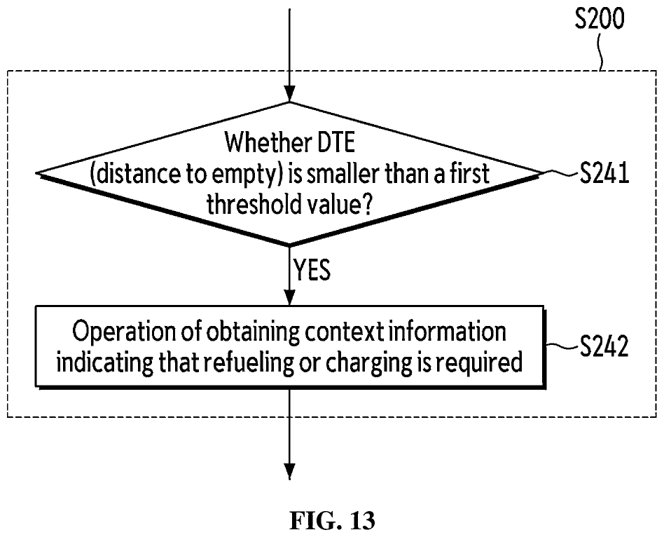

Referring to FIG. 13, in operation S241, it may be determined whether the DTE (distance to empty) is smaller than a first threshold value. When the DTE is smaller than the first threshold value (YES), context information indicating that refueling or charging is required may be acquired in operation S242. In this case, the priority of the gas station/charging station category may be set to be high in operation S300.

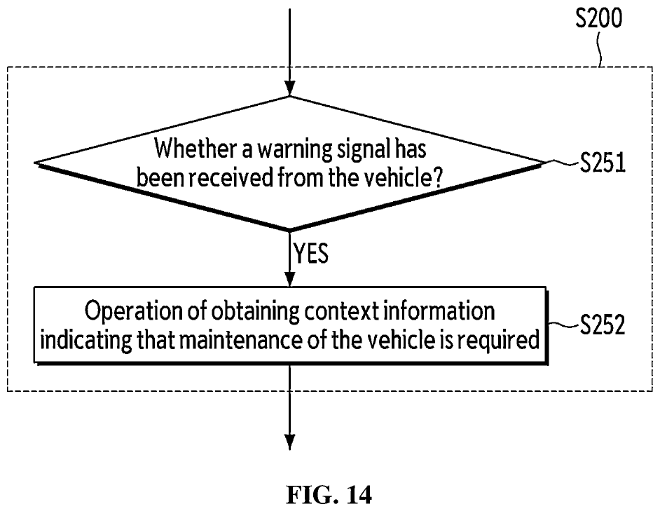

Referring to FIG. 14, in operation S251, it may be determined whether a warning signal has been received from the vehicle. For example, the warning signal may include warnings that require immediate inspection of components of the vehicle, such as engine oil warning, battery warning, airbag warning, brake warning, coolant overheating warning, and warnings that require inspection of components of the vehicle within a short period of time, such as attitude control device warning, engine warning, washer fluid warning, immobilizer warning, and tire pressure warning. These warnings may be signals displayed on an instrument panel in a form of a red warning light or a yellow warning light. When the warning signal has been received from the vehicle (YES), context information indicating that vehicle maintenance is required may be acquired in operation S252. In this case, the priority of the maintenance station category may be set to be high in operation S300.

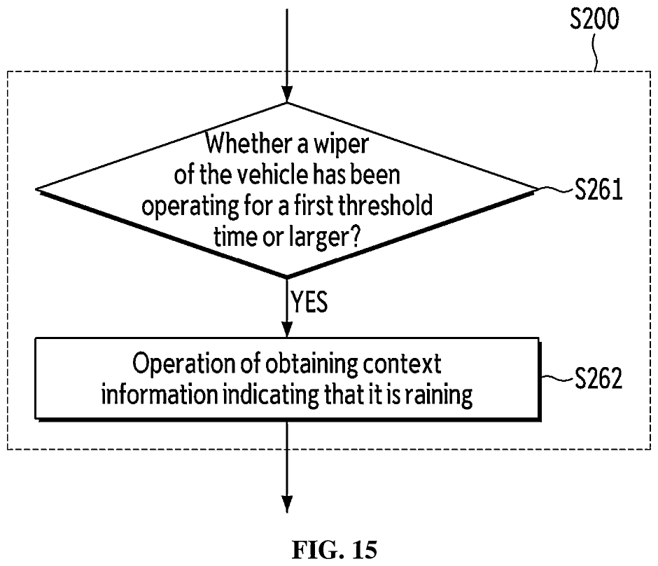

Referring to FIG. 15, in operation S261, it may be determined whether the vehicle's wiper is operating for a first threshold time or larger. When the wiper is operating for the first threshold time or larger (YES), it is determined that the wiper is operating continuously because it is raining, and thus, in operation S262, context information indicating that it is raining may be obtained. In this case, in operation S300, the priority of the professional car wash or scenic road category may be set to be low.

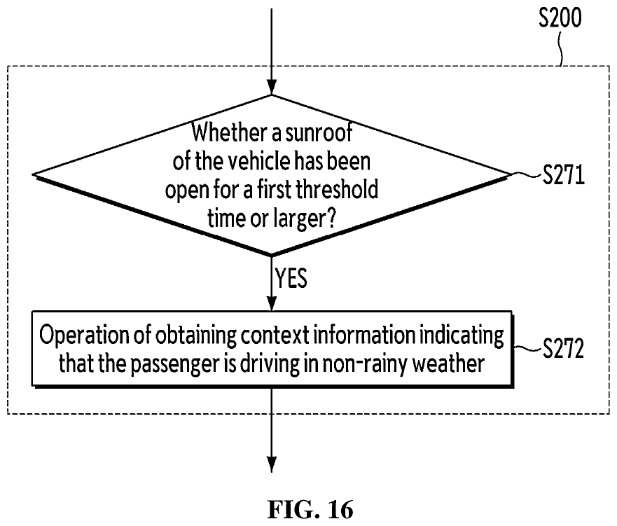

Referring to FIG. 16, in operation S271, it may be determined whether the vehicle's sunroof is open for a first threshold time or larger. When the sunroof is open for the first threshold time or larger (YES), it is determined that the sunroof is open continuously because the weather is good, and thus, in operation S272, context information indicating that the passenger is driving in non-rainy weather may be obtained. In this case, in operation S300, the priority of the scenic road category may be set to be high.

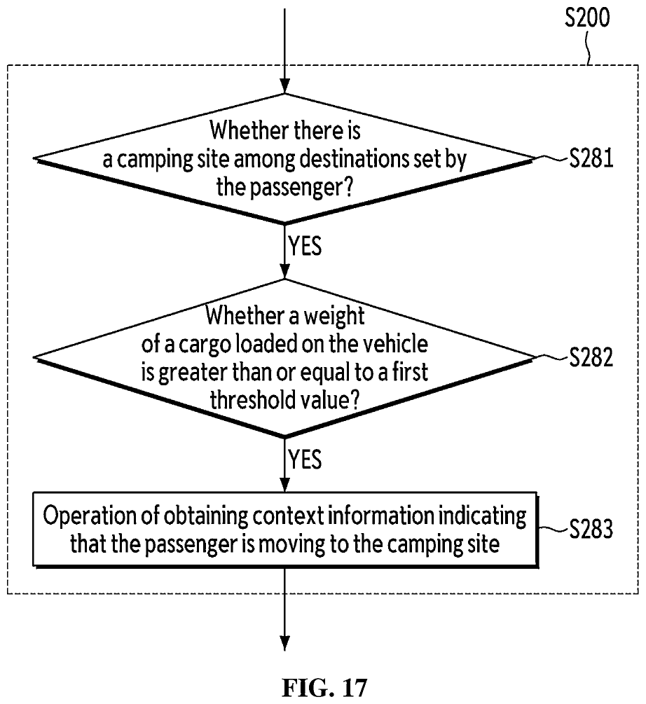

Referring to FIG. 17, in operation S281, it may be determined whether there is a camping site among the destinations recently set by the passenger. When there is the camping site among the destinations set by the passenger (YES), context information indicating that the passenger is a camper may be obtained first. In this regard, in operation S282, it may be determined whether a weight of a cargo currently loaded in the vehicle is greater than or equal to a first threshold value. For example, the first threshold value may be set to an average weight of camping devices. When the weight is greater than or equal to the first threshold value (YES), in operation S283, context information indicating that the passenger is moving to the camping site may be obtained. In this case, in operation S300, the priority of the camping site category may be set to be high. Although the embodiment of FIG. 17 has been described above using camping as an example, the present disclosure is not limited thereto. The weight of the loaded cargo may also be used to identify other context information related to the passenger.

FIG. 18 is a block diagram showing a hardware configuration of a computing device 500 for performing the search category varying method according to an embodiment of the present disclosure.

Referring to FIG. 18, the computing device 500 may include one or more processors 510, a bus 530, a communication interface 540, a memory 520 that loads a computer program executed by the processor 510 therein, and a storage 550 that stores a computer program 560 therein. However, only components related to an embodiment of the present disclosure are illustrated in FIG. 11. Therefore, a person skilled in the art in the technical field to which the present disclosure belongs may understand that other general components than the components as illustrated in FIG. 11 may be included in the computing device.

In other words, the computing device 500 may include various components in addition to the components as illustrated in FIG. 11. Furthermore, in some cases, the computing device 500 may be configured such that some of the components as illustrated in FIG. 11 are omitted. Hereinafter, each of the components of the computing device 500 is described.

The processor 510 may control all operations of the components of the computing device 500. The processor 510 may be configured to include at least one of a CPU Central Processing Unit, an MPU Micro Processor Unit, an MCU Micro Controller Unit, a GPU Graphics Processing Unit, or any further type of a processor well known in the technical field of the present disclosure. Furthermore, the processor 510 may perform computations of at least one application or program for executing operations/methods according to some embodiments of the present disclosure. The computing device 500 may have one or more processors.

Next, the memory 520 may store therein various data, commands, and/or information. The memory 520 may cargo therein the computer program 560 from the storage 550 to execute operations/methods according to some embodiments of the present disclosure. The memory 520 may be embodied as a volatile memory such as RAM. However, the present disclosure is not limited thereto.

Next, the bus 530 may provide a communication function between the components of the computing device 500. The bus 530 may be embodied as various types of buses such as an address bus, a data bus, and a control bus.

Next, the communication interface 540 may support wired and wireless Internet communication of the computing device 500. Furthermore, the communication interface 540 may support various communication schemes other than Internet communication. To this end, the communication interface 540 may be configured to include a communication module well known in the technical field of the present disclosure.

Next, the storage 550 may non-temporarily store therein one or more computer programs 560. The storage 550 may be configured to include a non-volatile memory such as Read Only Memory ROM, Erasable Programmable ROM EPROM, Electrically Erasable Programmable ROM EEPROM, flash memory, a hard disk, a removable disk, or any form of computer-readable recording medium well known in the art to which the present disclosure belongs.

Next, the computer program 560 may include one or more instructions that cause the processor 510 to perform the operations/methods according to various embodiments of the present disclosure when being loaded into the memory 520. That is, the processor 510 may execute one or more loaded instructions to perform the operations/methods according to various embodiments of the present disclosure.

For example, the computer program 560 may include instructions, wherein when the instructions are executed by the processor, the instructions cause the processor to perform: obtaining vehicle information indicating a state of a vehicle from the vehicle; obtaining context information indicating a situation of a passenger using the acquired vehicle information; determining respective priorities of a plurality of surrounding search categories, based on the acquired context information; and displaying the plurality of surrounding search categories under the determined priorities.

According to an embodiment of the present disclosure, the surrounding search category may vary based on the situation of the passenger, such that a destination that better suits the user's needs may be displayed first as a search result, thereby providing convenience to the user. Furthermore, unlike a navigation operating on a mobile terminal, more precise varying of the search category may be achieved based on unique information that may be obtained from the vehicle.

Various embodiments and the effects thereof according to the present disclosure have been mentioned with reference to FIGS. 1 through 11. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A computing device, comprising:
a processor; and
a memory connected to the processor and configured to store therein instructions,
wherein when the instructions are executed by the processor, the instructions cause the processor to perform a method comprising:
obtaining from a vehicle a vehicle information indicating a state of the vehicle;
obtaining a context information indicating a situation of a passenger using the vehicle information;
determining respective priorities of a plurality of surrounding search categories based on the context information; and
displaying the plurality of surrounding search categories under the respective priorities.

2. The computing device of claim 1, wherein the vehicle information includes a vehicle location information, an information on whether a child lock is activated, a distance to empty (DTE) information indicating a fuel level, an information on whether a warning signal is received from the vehicle, an information on whether a wiper is in operation, an information on whether a sunroof is open or closed, or a weight of a loaded cargo.

3. The computing device of claim 1, wherein the determining the respective priorities of the plurality of surrounding search categories includes setting a priority of a first surrounding search category related to the context information among the plurality of surrounding search categories to a highest level or a lowest level.

4. The computing device of claim 3, wherein the determining the respective priorities of the plurality of surrounding search categories includes determining a priority related to each item of the first surrounding search category.

5. The computing device of claim 1, wherein the obtaining the context information indicating the situation of the passenger includes obtaining the context information using information about a current time, a real-time traffic situation, and a specific location.

6. The computing device of claim 1, wherein the obtaining the context information indicating the situation of the passenger includes:
comparing an information of a current location with an information of a reference location;
determining whether a distance between the current location and the reference location is greater than or equal to a first threshold value; and
obtaining a first context information indicating that the passenger is traveling when the distance between the current location and the reference location is greater than or equal to the first threshold value.

7. The computing device of claim 6, wherein the obtaining the first context information indicating that the passenger is traveling includes:
determining whether a distance between a destination and a first location is smaller than a second threshold value; and
obtaining a second context information indicating that the passenger is traveling to the first location when the distance between the destination and the first location is smaller than the second threshold value.

8. The computing device of claim 1, wherein the obtaining the context information indicating the situation of the passenger includes:
determining whether a child lock is turned on; and
obtaining a third context information indicating that a child is seated in the vehicle when the child lock is turned on.

9. The computing device of claim 8, wherein the determining the respective priorities of the plurality of surrounding search categories includes:
determining whether children are allowed to enter each item of each of the plurality of surrounding search categories; and
determining a priority of the each item based on a result of the determining whether the children are allowed to enter the each item.

10. The computing device of claim 1, wherein the obtaining the context information indicating the situation of the passenger includes:
determining whether a current time is included in a preset meal time; and
obtaining a fourth context information indicating that the current time is a meal time when the current time is included in the preset meal time.

11. The computing device of claim 10, wherein the obtaining the context information indicating the situation of the passenger further includes:
determining whether a departure point is a meal serving place; and
obtaining a fifth context information indicating that the current time is a dessert time when the departure point is the meal serving place.

12. The computing device of claim 1, wherein the obtaining the context information indicating the situation of the passenger further includes:
determining whether a destination is a downtown area;
obtaining a population density of the destination based on an obtained location information when the destination is the downtown area;
determining whether the population density of the destination is greater than or equal to a second threshold value; and
obtaining a sixth context information indicating that a parking space is required when the population density of the destination is greater than or equal to the second threshold value.

13. The computing device of claim 1, wherein the obtaining the context information indicating the situation of the passenger includes:
determining whether a DTE is smaller than a third threshold value; and
obtaining a seventh context information indicating that refueling or charging is required when the DTE is smaller than the third threshold value.

14. The computing device of claim 1, wherein the obtaining the context information indicating the situation of the passenger includes:
determining whether a warning signal has been received from the vehicle; and
obtaining an eighth context information indicating that a maintenance of the vehicle is required when the warning signal has been received therefrom.

15. The computing device of claim 1, wherein the obtaining the context information indicating the situation of the passenger includes:
determining whether a wiper of the vehicle has been operating for a first threshold time or larger; and
obtaining a ninth context information indicating that it is raining when the wiper of the vehicle has been operating for the first threshold time or larger.

16. The computing device of claim 1, wherein the obtaining the context information indicating the situation of the passenger includes:
determining whether a sunroof of the vehicle has been open for a second threshold time or larger; and
obtaining a tenth context information indicating that the passenger is driving in non-rainy weather when the sunroof of the vehicle has been open for the second threshold time or larger.

17. The computing device of claim 1, wherein the obtaining the context information indicating the situation of the passenger includes:
determining whether there is a camping site among destinations set by the passenger;
determining whether a weight of a cargo loaded on the vehicle is greater than or equal to a fourth threshold value when there is the camping site among the destinations; and
obtaining an eleventh context information indicating that the passenger is moving to the camping site when the weight of the cargo loaded on the vehicle is greater than or equal to the fourth threshold value.

18. A search category varying method performed by a computing device, the method comprising:
obtaining from a vehicle a vehicle information indicating a state of the vehicle;
obtaining a context information indicating a situation of a passenger using the vehicle information;
determining respective priorities of a plurality of surrounding search categories, based on the context information; and
displaying the plurality of surrounding search categories under the respective priorities.

19. The search category varying method of claim 18, wherein the vehicle information includes a vehicle location information, an information on whether a child lock is activated, a DTE information indicating a fuel level, an information on whether a warning signal is received from the vehicle, an information on whether a wiper is in operation, an information on whether a sunroof is open or closed, or a weight of a loaded cargo.

20. The search category varying method of claim 18, wherein the determining the respective priorities of the plurality of surrounding search categories includes setting a priority of a first surrounding search category related to the context information among the plurality of surrounding search categories to a highest level or a lowest level.
